(19) United States
(12) Patent Application Publication
(10) Pub. No.: US 2011/0310593 A1
(43) Pub. Date: Dec. 22, 2011

(54) LIGHT EMITTING GLOVE

(75) Inventors: James Lee, Taipei (TW); Hong-Hsu Huang, Taipei (TW); Chi Shu Kang, Taipei (TW); I Chen Su, Taipei (TW)

(73) Assignees: KING'S METAL FIBER TECHNOLOGIES CO., LTD., Taipei (TW); TEX-RAY INDUSTRIAL CO., LTD., Taipei (TW)

(21) Appl. No.: 13/165,744

(22) Filed: Jun. 21, 2011

(30) Foreign Application Priority Data
Jun. 22, 2010 (TW) 099120371

(51) Int. Cl. F21V 21/08; A41D 19/00

(52) U.S. Cl. 362/103; 2/160

(57) ABSTRACT

A light emitting glove is provided. The light emitting glove has a textile body and a light source device. The textile body has a first conductive portion and at least one second conductive portion, formed with a first conductive wire and at least one second conductive wire respectively. The light source device is disposed on a surface of the textile body. The light source device has a first end and a second end, electrically connected to the first conductive wire and the at least one second conductive wire respectively. When the first conductive wire of the first conductive portion contacts with the at least one second conductive wire of the at least one second conductive portion, the first end and the second end are conducted to enable the light source device to emit light.

This application claims the benefit of priority based on Taiwan Patent Application No. 099120371 filed on Jun. 22, 2010, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a light emitting glove, and more particularly, to a glove that is made to emit light simply by having finger portions to make contact with each other.

2. Descriptions of the Related Art

With wide spread of the concept of energy saving and carbon-emission reduction, use of various vehicles (e.g., bicycles, electromobiles and the like) that can reduce environmental pollution has become one of the essential ways for the public to practice the concept of environmental protection. Among such vehicles, bicycles not only serve as a transportation means for people to commute within a short distance but also provide the benefit of enhancing physical health through exercises. Therefore, bicycling has become very popular worldwide in recent years. In order to improve the safety of passersby and bicyclers at night, various light alerting products for bicycles have been gradually developed, among which a glove having the light emitting function is the most preferred in terms of the convenience, flexibility and alerting effect.

A conventional light emitting glove is embedded with a light source device so that, through a switching device of the light source device, a user can control the light emitting glove to emit light for alerting purpose. For example, if the light source device comprises a light emitting diode (LED) lamp which is electrically connected to the switching device of the light source device, then when the user does not press the switching device, a circuit of the LED lamp is in an off status and accordingly, the LED lamp remains turned off However, when the bicycler applies a force to turn on the switching device, the circuit of the LED lamp enters into an on status so as to enable the LED lamp to emit light. Thereby, during the bicycling (particularly at night), a light alert can be addressed to surrounding vehicles and passersby.

However, to make the circuit of the LED lamp enter into the on status so that the light source device could emit light for alerting purpose, the conventional switching-type light emitting glove requires the bicycler to divert his attention from bicycling to locate the position of the switch, or even to control the steering head by one hand while using the other hand pressing the switching device which requires a sufficient force. This is particularly inconvenient in operation; and moreover, when the alerting action is completed, the bicycler still needs to divert his attention from bicycling again to turn off the switching device.

Consequently, when turning off the LED lamp, the bicycler who is focusing his attention on switching the LED lamp may suffer a dangerous accident, which would endanger the life safety of the bicycler.

In view of this, an urgent need exists in the art to provide a light emitting glove, which is easier to operate than conventional light emitting gloves so as to increase the safety of users.

### SUMMARY OF THE INVENTION

The primary objective of the present invention is to provide a light emitting glove, which comprises a textile body and a light source device. The textile body further has a first conductive portion and at least one second conductive portion, formed with a first conductive wire and at least one second conductive wire respectively. The light source device is disposed on a surface of the textile body, and the light source device further comprises a first end and a second end, electrically connected to the first conductive wire and the at least one second conductive wire respectively. When the first conductive wire of the first conductive portion contacts with the at least one second conductive wire of the at least one second conductive portion, the first end and the second end are electrically connected and the light source device is turned on.

A further objective of the present invention is to provide a light emitting glove, which comprises a textile body and a light source device. The textile body further has a first conductive portion and at least one second conductive portion, formed with a first conductive wire and at least one second conductive wire respectively. The light source device is disposed on a surface of the textile body, and the light source device is electrically connected to the first conductive wire and the at least one second conductive wire respectively. When the first conductive wire of the first conductive portion contacts with the at least one second conductive wire of the at least one second conductive portion, the light source device is turned on; and when the first conductive wire of the first conductive portion contacts with the at least one second conductive wire of the at least one second conductive portion again, a first end and a second end are disconnected to turn off the light source device.

According to the above descriptions, the light emitting glove of the present invention has a light source device incorporated therein, and by contacting the first conductive portion with the at least one second conductive portion, the light source device can be turned on to emit light. In other words, the light emitting glove of the present invention can achieve the switching function without a physical switching device. Therefore, the disadvantages of the prior art can be overcome effectively to increase the overall value of the light emitting glove.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective front view of an embodiment of the present invention;

FIG. 2A is a front view of the embodiment of the present invention;

FIG. 2B is a back view of the embodiment of the present invention; and

FIG. 3 is a perspective front view of another embodiment of the present invention.

### DESCRIPTION OF THE PREFERRED EMBODIMENT

In the following description, the present invention will be explained with reference to embodiments thereof. However, description of these embodiments is only for purpose of illustration rather than to limit the present invention. It shall be appreciated that, in the following embodiments and the attached drawings, elements not directly related to the present invention are omitted from depiction; and dimensional and positional relationships among individual elements in the attached drawings are illustrated only for ease of understanding but not to limit the actual scale and size.

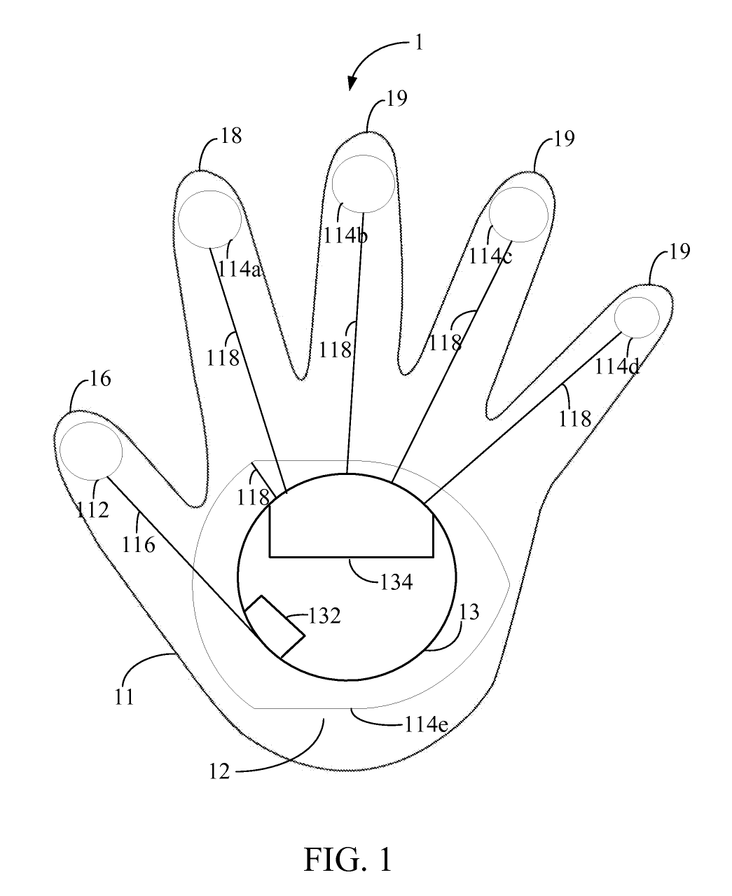

A perspective view of a light emitting glove 1 according to an embodiment of the present invention is shown in FIG. 1. The light emitting glove 1 comprises a textile body 11, a light source device 13 and a battery (not shown). The light source device 13 is disposed on a surface of the textile body 11, and the battery is configured to supply power to the light source device 13. Hereinafter, members of the textile body 11 and the light source device 13 and connection relationships therebetween will be described in detail.

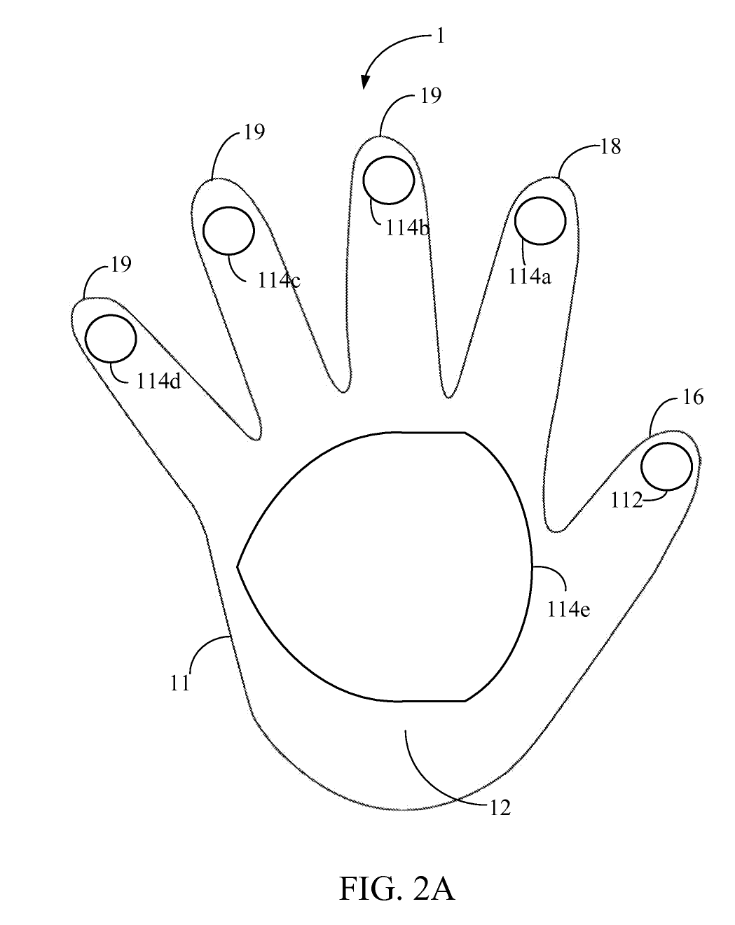

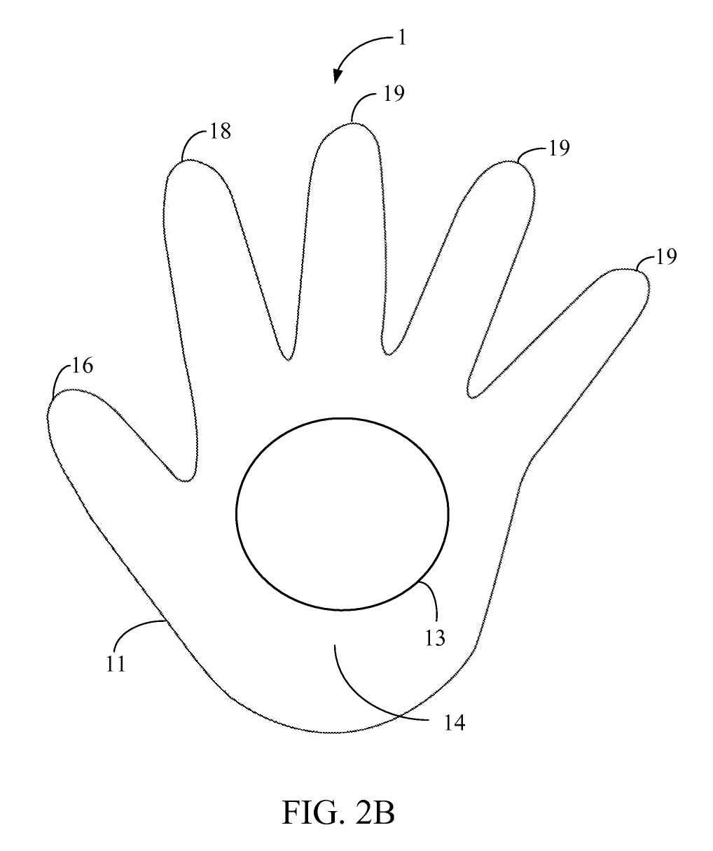

Firstly, referring to FIG. 2A together, there is shown a front view of the light emitting glove 1. The textile body 11 comprises a first conductive portion 112 and five second conductive portions 114a, 114b, 114c, 114d, 114e, the first conductive portion 112 is formed with a first conductive wire 116, and each of the second conductive portions 114 is formed with a second conductive wire 118. In this embodiment, the first conductive portion 112 and the second conductive portions 114a, 114b, 114c, 114d all have a circular shape, and the textile body 11 may be divided into a palm portion 12, a back portion 14, a thumb fingertip portion 16, a forefinger fingertip portion 18 and three other fingertip portions 19. In other aspects, the fingertip portion would not be limited only to fingertips and could be any portion of the glove's finger portion. For instance, the textile body of a fingerless glove may be divided into a palm portion, a back portion, a thumb knuckle portion, a forefinger knuckle portion and three other three knuckle portions.

As depicted in FIG. 2A, the first conductive portion 112 is disposed on the thumb fingertip portion 16, the second conductive portions 114a, 114b, 114c, 114d are disposed on the forefinger fingertip portion 18 and the other fingertip portions 19 respectively, and the second conductive portion 114e has an irregular shape and is disposed on the palm portion 12. In other embodiments, the first conductive portion and the second conductive portions may have a helical shape, a circular shape, an elliptic shape, a square shape, an irregular shape, and the like. Embodiments in which different numbers of second conductive portions are provided or the conductive portions are disposed at different positions can also be inferred by people skilled in the art according to the aforesaid concept of the present invention.

Referring to FIG. 2B, there is shown a back view of the light emitting glove 1. The light source device 13 is disposed on a surface of the back portion 14 of the textile body 11. The light source device 13 has a first end 132 and a second end 134, which are electrically connected to the first conductive wire 116 and the second conductive wires 118 respectively.

Please referring to FIG. 1 once more, the first conductive wire 116 of the first conductive portion 112 on the thumb fingertip portion 16 electrically connects to the first end 132 of the light source device 13, and one of the second conductive wires 118 of the second conductive portion 114a on the forefinger fingertip portion 18 electrically connects to the second end 134 of the light source device 13; therefore, when the first conductive wire 116 of the first conductive portion 112 contacts with the second conductive wire 118 of the second conductive portion 114a on the forefinger fingertip portion 18, the first end 132 and the second end 134 are electrically connected to enable the light source device 13 to emit light. In other words, because the first conductive portion 112 is disposed on the thumb fingertip portion 16 and the second conductive portion 114a is disposed on the forefinger fingertip portion 18, therefore the light source device 13 can emit light by only lightly contacting the thumb fingertip portion 16 with the forefinger fingertip portion 18.

The second conductive portions 114b, 114c, 114d on the other fingertip portions 19 and the second conductive portion 114e on the palm portion 12 are all formed with a second conductive wire 118 respectively thereon so that the second conductive wires 118 electrically connect the second conductive portions 114b, 114c, 114d, 114e to the second end 134 of the light source device 13. Therefore, when the second conductive wire 118 of any one of the second conductive portions 114b, 114c, 114d, 114e contacts with the first conductive wire 116 of the first conductive portion 112, the first end 132 and the second end 134 of the light source device 13 can also be electrically connected to enable the light source device 13 to emit light. Furthermore, as the palm portion 12 is also formed with the second conductive portion 114e thereon, the light source device 13 can be made to emit light by only lightly contacting the thumb fingertip portion 16 with the palm portion 12.

Accordingly, it is only necessary for a user to contact the first conductive portion 112 with one of the second conductive portions 114a, 114b, 114c, 114d, 114e. However, as will be readily appreciated by those of ordinary skill in the art, the first conductive portion and the second conductive portions may also be disposed on any two of the palm portion and the plurality of fingertip portions in other embodiments. Similarly, it could be easily for one skilled in the art to practice the invention in a fingerless glove, the first conductive portion and the second conductive portion could be disposed on any two of the palm portion and the plurality of knuckle portions of this fingerless glove. Therefore, the first conductive portion and the second conductive portions are not limited to being located at particular blocks in the light emitting glove, and the aforesaid way of making a contact is only illustrative but is not intended to limit the present invention.

In this embodiment, the first conductive wire 116 and the second conductive wires 118 are made of a metal; however, in other embodiments, the first conductive wire 116 and the second conductive wires 118 may also be made of one of stainless steel fiber, copper fiber, carbon fiber and sputtered silver.

Additionally, in this embodiment, the textile body 11 is made of a fabric woven from insulation fibers. Further, the insulation fibers are conventional nonconductive fibers, and a material of the insulation fibers could be, for example, polyester, polyethylene terephthalate

(PET), cotton yarn, polyurethane (PU) and the like. In other embodiments, the textile body 11 may also be made of any other insulation material, film and thin film, which can be readily understood by those of ordinary skill in the art and thus will not be further described herein. As the textile body 11 is insulating, the light source device 13 will not be short-circuited via the human body to emit light.

In this embodiment, the light source device 13 is a light emitting diode (LED); however, those of ordinary skill in the art may also replace it with such light source devices as an optical fiber illumination element, an organic LED, an electro-luminence (EL) element, an interferometric modulation (IMOD) element or a bulb.

In this embodiment, light is emitted continuously. In other examples, light may be emitted flickeringly, or emit light continuously or discontinuously according to a time period.

In FIG. 2B, the light source device 13 may emit light either discontinuously or continuously. For further details, please referring back to FIG. 1, after the first end 132 and the second end 134 of the light source device 13 are electrically connected, the light source device 13 can emit light in a way varying with a conducting time period. For additional details, when the first conductive portion 112 contacts with one of the second conductive portions 114, the light source device 13 emits light continuously; and then, if the first conductive portion 112 has continuously contacted with the second conductive portion 114 for a preset time period (e.g., three seconds), the light source device 13 would emit discontinuously for power saving.

When a bicycler is riding a bicycle (particularly at night), he or she can put the light emitting gloves of the present invention on his both hands. When the bicycler is to turn right, he or she can have two of the fingertip portions of the right light emitting glove contact with each other so that the light source device emits light to alert following vehicles that the bicycler is to turn right, and after the alerting is completed, the fingertips' connection can be released to stop light emission. Similarly, when the bicycler is to turn left, he or she can have two of the fingertip portions of the left light emitting glove contact with each other so that the light source device emits light to alert following vehicles that the bicycler is to turn left, and after the alerting is completed, the fingertips are released to stop light emission.

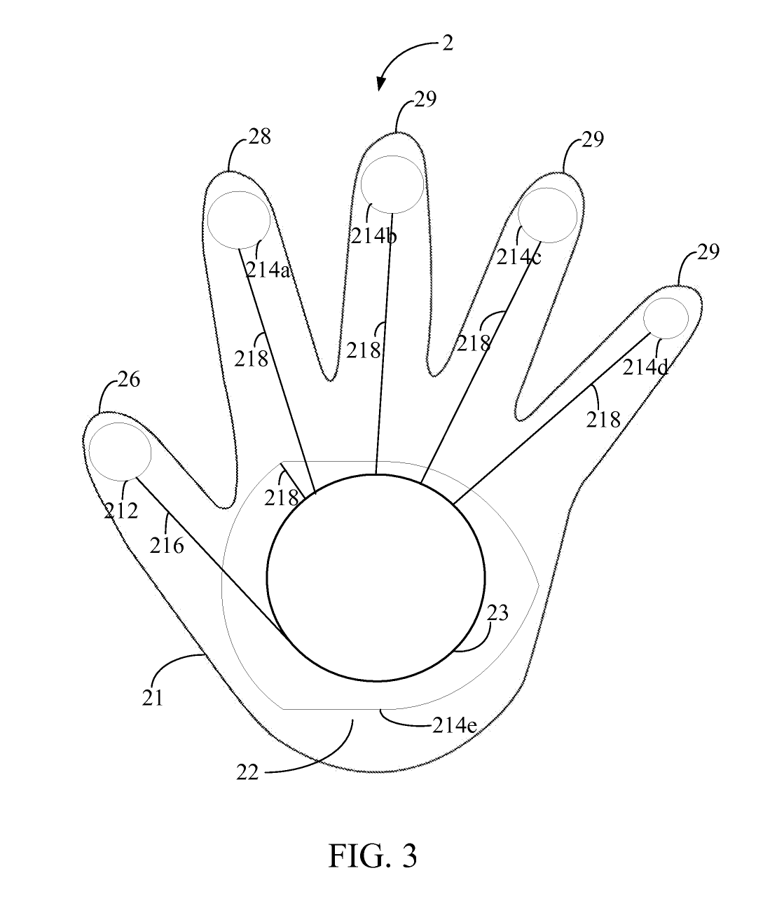

Another embodiment of the present invention is shown in FIG. 3. A light emitting glove 2 of this embodiment also comprises a textile body 21, a light source device 23 and a battery (not shown). The light source device 23 is disposed on a surface (not shown) of a back portion of the textile body 21, and the battery is configured to supply power to the light source device 23.

As shown in the FIG. 3, the textile body 21 comprises a first conductive portion 212 and five second conductive portions 214a, 214b, 214c, 214d, 214e. The first conductive portion 212 is formed with a first conductive wire 216, and each of the second conductive portions 214 is formed with a second conductive wire 218. In this embodiment, the first conductive portion 212 and the second conductive portions 214a, 214b, 214c, 214d all have a circular shape, and the textile body 21 may be divided into a palm portion 22, a thumb fingertip portion 26, a forefinger fingertip portion 28 and three other fingertip portions 29. In other aspects, the fingertip portion would not be limited only to fingertips and could be any portion of the glove's finger portion. For instance, the textile body of a fingerless glove may be divided into a palm portion, a back portion, a thumb knuckle portion, a forefinger knuckle portion and three other three knuckle portions.

As depicted in FIG. 3, the first conductive portion 212 is disposed on the thumb fingertip portion 26, the second conductive portions 214a, 214b, 214c, 214d are disposed on the forefinger fingertip portion 28 and the other fingertip portions 29 respectively, and the second conductive portion 214e has an irregular shape and is disposed on the palm portion 22.

As described in the previous embodiment, the first conductive portion and the second conductive portions may have various shapes, positions and numbers. When one skilled in the art to practice the invention in, a fingerless glove, the first conductive portion and the second conductive portion could be disposed on any two of the palm portion and the plurality of knuckle portions of this fingerless glove.

The first conductive wire 216 electrically connects the first conductive portion 212 on the thumb fingertip portion 26 to the light source device 23, and the second conductive wire 218 electrically connects the second conductive portion 214a on the forefinger fingertip portion 28 to the light source device 23; therefore, when the first conductive wire 216 of the first conductive portion 212 on the thumb fingertip portion 26 contacts with the second conductive wire 218 of the second conductive portion 214a on the forefinger fingertip portion 28, the light source device 23 can be turned on to emit light. Then, when the first conductive wire 216 of the first conductive portion 212 on the thumb fingertip portion 26 contacts with the second conductive wire 218 of the second conductive portion 214a on the forefinger fingertip portion 28 again, the light source device is turned off to stop emitting light.

Furthermore, the second conductive portions 214b, 214c, 214d on the other fingertip portions 29 and the second conductive portion 214e on the palm portion 22 are all formed with a second conductive wire 218 respectively thereon so that the second conductive wires 218 electrically connect the second conductive portions 214b, 214c, 214d, 214e to the light source device 23. Therefore, when the second conductive wire 218 of any one of the second conductive portions 214b, 214c, 214d, 214e contacts with the first conductive wire 216 of the first conductive portion 212, the light source device 23 can also be turned on to emit light; and then, when the second conductive wire 218 of any one of the second conductive portions 214b, 214c, 214d, 214e contacts with the first conductive wire 216 of the first conductive portion 212 again, the light source device 23 can be turned off. It shall be appreciated that, the one of the second conductive portions 214a, 214b, 214c, 214d, 214e for turning on the light source device 23 is not necessarily the exact one of the second conductive portions 214a, 214b, 214c, 214d, 214e for turning off the light source device 23. Accordingly, it is only necessary for a user to contact the first conductive portion 212 with any one of the second conductive portions 214a, 214b, 214c, 214d, 214e to turn on or turn off the light source device 23.

Materials, structures and related descriptions of the individual elements in this embodiment are similar to those described in the previous embodiment, and thus will not be further described herein. For example, the light source device 23 of this embodiment may also be embodied to emit light flickeringly or to emit light continuously or discontinuously depending on a time period. Other aspects of this embodiment are also similar to those described in the aforesaid embodiment; and other embodiments of the present invention can be readily inferred by those of ordinary skill in the art based on the aforesaid embodiment and the prior art, and thus will not be further described herein.

It shall be appreciated that, the light emitting glove of the present invention can be widely applied to various fields, but is not limited to use by bicyclers. For example, the light emitting glove of the present invention may be used by traffic police who direct the traffic at night, or in any other activities in which a light source is needed for alerting purpose.

According to the above descriptions, through combination of the textile body and the light source device in the light emitting glove of the present invention, when the fingertip portions of the textile body contact with each other or any one of the fingertip portions contacts with the palm portion, the first conductive portion and the second conductive portions disposed on the fingertip portions and the palm portion will contact with each other so that the first end and the second end of the light source device can be electrically connected to enable the light source device to emit light. In this way, the user can turn on or turn off the light source through simple contact of the light emitting glove of the present invention without diverting his attention. Therefore, the disadvantages of the prior art can be overcome effectively to increase the overall value of the light emitting glove.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A light emitting glove, comprising:
a textile body, having a first conductive portion and at least one second conductive portion, formed with a first conductive wire and at least one second conductive wire respectively; and
a light source device, being disposed on a surface of the textile body, the light source device comprising a first end and a second end, electrically connected to the first conductive wire and the at least one second conductive wire respectively;
wherein when the first conductive wire of the first conductive portion contacts with the at least one second conductive wire of the at least one second conductive portion, the first end and the second end are electrically connected to turn on the light source device.

2. The light emitting glove as claimed in claim 1, wherein the at least one second conductive portion comprises a plurality of second conductive portions, the at least one second conductive wire comprises a plurality of second conductive wires, each of the second conductive portions comprises one of the second conductive wires, each of the second conductive wires is electrically connected to the second end of the light source device, and when the first conductive wire contacts with one of the second conductive wires, the first end and the second end are electrically connected to turn on the light source device.

3. The light emitting glove as claimed in claim 1, wherein the textile body comprises a palm portion, a back portion and a plurality of finger portions.

4. The light emitting glove as claimed in claim 3, wherein the first conductive portion and the at least one second conductive portion are separately disposed on any two of the finger portions and the palm portion.

5. The light emitting glove as claimed in claim 4, wherein the light source device is turned on when any two of the finger portions contact or when any one of the finger portions contacts with the palm portion.

6. The light emitting glove as claimed in claim 3, wherein the light source device is disposed on the back portion.

7. The light emitting glove as claimed in claim 1, wherein the light source device is turned on to flicker or to illuminate continuously.

8. The light emitting glove as claimed in claim 1, wherein a material of the conductive wires is one of metal, stainless steel fiber, copper fiber, carbon fiber and sputtered silver.

9. A light emitting glove, comprising:
a textile body, having a first conductive portion and at least one second conductive portion, formed with a first conductive wire and at least one second conductive wire respectively; and
a light source device, being disposed on a surface of the textile body, the light source device being electrically connected to the first conductive wire and the at least one second conductive wire;
wherein when the first conductive wire of the first conductive portion contacts with the at least one second conductive wire of the at least one second conductive portion, the light source device is turned on; and when the first conductive wire of the first conductive portion contacts with the at least one second conductive wire of the at least one second conductive portion again, the light source device is turned off.

10. The light emitting glove as claimed in claim 9, wherein the at least one second conductive portion comprises a plurality of second conductive portions, the at least one second conductive wire comprises a plurality of second conductive wires, each of the second conductive portions comprises one of the second conductive wires, when the first conductive wire contacts with one of the second conductive wires, the light source device is turned on, and when the first conductive wire contacts with one of the second conductive wires again, the light source device is turned off

11. The light emitting glove as claimed in claim 9, wherein the textile body comprises a palm portion, a back portion and a plurality of finger portions.

12. The light emitting glove as claimed in claim 11, wherein the first conductive portion and the at least one second conductive portion are separately disposed on any two of the finger portions and the palm portion.

13. The light emitting glove as claimed in claim 11, wherein the light source device is disposed on the back portion.

14. The light emitting glove as claimed in claim 9, wherein the light source device is turned on to flicker or to illuminate continuously.

15. The light emitting glove as claimed in claim 9, wherein a material of the conductive wires is one of metal, stainless steel fiber, copper fiber, carbon fiber and sputtered silver.
